(19) United States
(12) Patent Application Publication
(10) Pub. No.: US 2017/0052701 A1
(43) Pub. Date: Feb. 23, 2017

(54) DYNAMIC VIRTUAL KEYBOARD GRAPHICAL USER INTERFACE

(71) Applicants: Alex Rosenfeld, Santa Monica, CA (US); Kuangwei Hwang, Los Angeles, CA (US); Mikal Saltveit, los angeles, CA (US); Elyse Bromser-Kloeden, mckinney, TX (US)

(72) Inventors: Alex Rosenfeld, Santa Monica, CA (US); Kuangwei Hwang, Los Angeles, CA (US); Mikal Saltveit, los angeles, CA (US); Elyse Bromser-Kloeden, mckinney, TX (US)

(73) Assignee: Vrideo, Los Angeles, CA (US)

(21) Appl. No.: 15/242,095

(22) Filed: Aug. 19, 2016

Related U.S. Application Data
(60) Provisional application No. 62/207,188, filed on Aug. 19, 2015.

(51) Int. Cl. G06F 3/0488; G06T 13/20; G06F 3/0489; G06F 3/0484; G06F 3/0481; G06T 19/00; G06F 3/01

(52) U.S. Cl. CPC G06F 3/04886; G06T 19/006; G06T 13/20; G06F 3/012; G06F 3/04842; G06F 3/04812; G06F 3/013; G06F 3/04815; G06F 3/0489

(57) ABSTRACT

A method for receiving input, by a virtual reality system includes creating a three-dimensional (3D) mesh for a virtual space. The 3D mesh includes a virtual keyboard, where the keyboard object comprises a plurality of virtual keys, a collision object corresponding to each of the plurality of virtual keys, and a cursor. The virtual reality system displays the 3D mesh on a head-mounted display (HMD), receives user input for moving a location of the cursor in the virtual space, and receives user input for selecting the collision object of one of the plurality of virtual keys based on the location of the cursor.

### CROSS-REFERENCE TO RELATED APPLICATION

This application claims the benefit of U.S. Provisional Patent Application Ser. No. 62/207,188 entitled “VIRTUAL KEYBOARD USER INTERFACE”, which was filed Aug. 19, 2015. The aforementioned application is herein incorporated by reference in its entirety.

### FIELD

This application relates to graphical user interfaces, and more particularly to a system and method for a virtual keyboard graphical user interface for use in a three-dimensional virtual world.

### BACKGROUND

Virtual reality (VR) systems present users with computer-generated three-dimensional (3D) images. Virtual Reality systems immerse the user in a virtual world. Essentially all visual stimulation is blocked out except that provided by the VR system.

Most VR systems use personal computers with powerful graphics capabilities to run software and display a VR environment. To display the VR environments, many VR systems use head-mounted displays (HMDs). Most HMDs include two displays, one for each eye, to create a stereoscopic effect and give the illusion of depth. In some cases, the HMDs can include on-board processing and operating systems to allow application to run locally, which eliminates any need for physical tethering to an external device. Some HMDs incorporate positioning systems that track the user's head position and angle to allow a user to virtually look around a VR environment simply by moving his head. Some HMDs may also track eye movement and hand movement to bring additional details to attention and allow natural interactions with the VR environment.

VR systems, with the use of a HMD, can track the user's head or and therefore the user's viewpoint, so that graphics can be rendered from the user's viewpoint. The HMDs track's the user's head's physical location as well as rotation and accordingly changes the virtual or augmented view displayed.

When the user interacts with a software application on a data processing system, the software application may cause the data processing system to display various input objects for collecting information from the user. These input objects may include text fields and graphical user interface (GUI) objects. For example, an email software application may display a window GUI that prompts the user for login credentials, a bookkeeping application may present a user interface for recording business expenses, or an Internet browser application may present a web page for registering with a social interaction website or a window for participating in online chat.

Many different types of physical user interface devices and methods are currently available for inputting user commands. Common tactile interface devices include keyboards, mice, gamepads, and touch screens. Touch screens detect the presence and location of a touch by a finger or other object within the display area. However, when using a head mounted VR display, the user may be unable to easily see and/or reach a physical keyboard or other common physical user interface devices.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In accordance with one or more aspects of the examples described herein, systems and methods are provided for virtual keyboard graphical user interface for use in a three-dimensional virtual world.

In a first aspect, a method for receiving input, by a virtual reality system includes creating a three-dimensional (3D) mesh for a virtual space. The 3D mesh includes a virtual keyboard, where the keyboard object comprises a plurality of virtual keys, a collision object corresponding to each of the plurality of virtual keys, and a cursor. The virtual reality system displays the 3D mesh on a head-mounted display (HMD), receives user input for moving a location of the cursor in the virtual space, and receives user input for selecting the collision object of one of the plurality of virtual keys based on the location of the cursor.

In a second aspect, a virtual reality system includes a head-mounted display (HMD), and a data processing device connected to the HDM. The data processing device is configured to create a three-dimensional (3D) mesh for a virtual space. The 3D mesh includes a virtual keyboard, where the keyboard object comprises a plurality of virtual keys, a collision object corresponding to each of the plurality of virtual keys, and a cursor. The data processing device is further configured to display the 3D mesh on a HMD, receive user input for moving a location of the cursor in the virtual space, and receive user input for selecting the collision object of one of the plurality of virtual keys based on the location of the cursor.

### BRIEF DESCRIPTION OF THE DRAWINGS

These and other sample aspects of the present technology will be described in the detailed description and the appended claims that follow, and in the accompanying drawings, wherein:

FIG. 1 illustrates a GUI of an example VR system;

FIG. 2 illustrates two keyboard layouts for a virtual keyboard of an example VR system;

FIG. 3 illustrates an example methodology for receiving user input by a VR system; and

FIG. 4 illustrates a block diagram of an example computer system.

### DETAILED DESCRIPTION

The subject disclosure provides techniques for providing a virtual keyboard graphical user interface (GUI), in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

The term “keyboard” is defined herein to comprise alphanumeric keyboards as well as foreign language keyboards and is not limited to QWERTY alphanumeric keyboards. Accordingly, it is understood that the use of the term “keyboard” and the depiction in any figures of a keyboard such as a QWERTY alphanumeric keyboard typically used with personal computers and the like is only an example of a keyboard for use, interaction, and operation by a user for any application of keyboards for input and/or output devices. As defined herein, the term “keyboard” is more than a plurality of keys, since a keyboard includes a layout of the plurality of keys as well as the keys, with the layout typically being predetermined. The keys may be associated with symbols such as alphabetical, numerical, mathematical, or other representations, and the keys may include associated pictorial or symbolic representations thereupon. Accordingly, a keyboard is not identical to a set of buttons, but may be a plurality of buttons having a layout and a set of symbols associated with each key or button.

The term “virtual reality” and its abbreviation “VR” are herein defined to include, but not to be limited to, visual and/or other sensory applications implemented using software and/or hardware to simulate and/or provide representations of environments which may be different from the physical environment of the user. Such VR may provide visual and/or multimedia zones, worlds, and work areas in which the user and/or other software applications may change and interact representations of elements in the VR environment. Accordingly, the term “virtual reality” is not limited to simulations or representations of VR devices and information in VR worlds, but may also be extended to physical devices as well as, in hybrid implementations, to both physical and VR devices.

In some implementations, a VR system includes a data processing device (e.g., personal computer, smart phone, tablet computer, laptop computer, etc.) and a head-mounted display (HMD). In some aspects, the data processing device and the HMD are combined into a single integrated device.

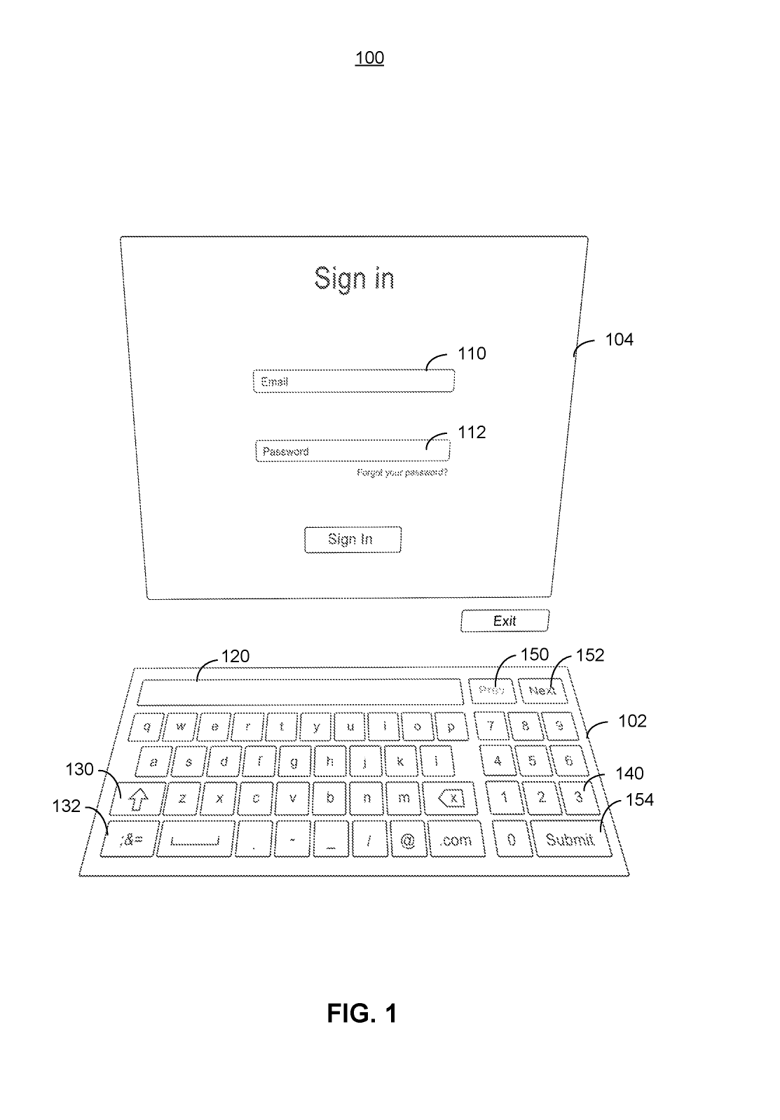

FIG. 1 illustrates a graphical user interface (GUI) 100 of an example VR system. The VR system constructs a GUI 100 for a virtual keyboard 102 in a virtual 3D world of a computer simulation. A GUI is a type of user interface that allows users to interact with electronic devices through graphical icons and visual indicators such as secondary notation, instead of text-based user interfaces, typed command labels or text navigation. A GUI uses a combination of technologies and devices to provide a platform for the tasks of gathering and producing information from users. The actions in a GUI are usually performed through direct manipulation of the graphical elements.

The virtual keyboard 102 of the GUI 100 allows a user used to write alphabetical, numerical, and special characters in text fields 110, 112 while inside a virtual space. For example, while wearing a HMD, a user can use the virtual keyboard 102 by rotating their head to look at individual keys, then selecting the key via a user input (i.e., a tap, click, etc.).

While wearing an HMD a user cannot see outside of the headset to utilize a physical keyboard, so the virtual keyboard 102 is useful by providing a familiar method of text entry while wearing one.

In some implementations, the VR system builds a virtual keyboard 102 using 3D meshes for various components of the virtual keyboard 102, such as, for example, a container, a preview pane 120, keys, etc.

A mesh is a collection of vertices, edges and faces that defines the shape of a polyhedral object for use in 3D modeling. The faces usually include triangles, quadrilaterals, or other simple convex polygons, but can also include more general concave polygons, or polygons with holes. A vertex is a position in a 3D space along with other information such as color, normal vector and texture coordinates. An edge is a connection between two vertices. A face is a closed set of edges (e.g., a triangle face has tree edges and a quad face has four edges).

Polygon meshes may be represented in a variety of ways, using different methods to store the vertex, edge and face data. Examples of polygon mesh representations include Face-vertex meshes, Winged-edge meshes, Half-edge meshes, Quad-edge meshes, Corner-table meshes, and Vertex-vertex meshes.

In some implementations, the various components of the virtual keyboard 102 are stored and/or organized into a hierarchy that maintains a relative position of each key on the virtual keyboard 102. In some related aspects, 3D meshes that share a same color (i.e., the key backgrounds or the key text) are batched together to reduce draw calls, which can decrease processor resource use on a user's device.

The virtual keys may comprise alphanumeric characters, a backspace key, a space bar, symbols, punctuation, and other such keys. Virtual keys may also include control keys (e.g., enter key, arrow keys, etc.) and function keys (e.g., F1, F2, F3, etc.).

In some implementations, the virtual keyboard 102 can have any keyboard layout. For example, a keyboard layout can be for standard text entry. Another keyboard layout can be specifically for entering web addresses or email addresses. In some implementations, the virtual keyboard allows the user to change from an alphabetical layout and a special character layout, with for example, a special character key 132. The user can toggle the alphabetical layout between upper and lower case letters, with for example, a shift key 130. In some implementations, they virtual keyboard layout includes a numerical section 140 on the right hand side of the virtual keyboard 102 for inputting numbers.

In some implementations, the virtual keyboard may only be required when entering characters into text fields 110, 112. In some implementations, the virtual keyboard automatically appears when the user selects a text field 110, 112. The virtual keyboard can be automatically hidden when a user has not selected a text field 110, 112.

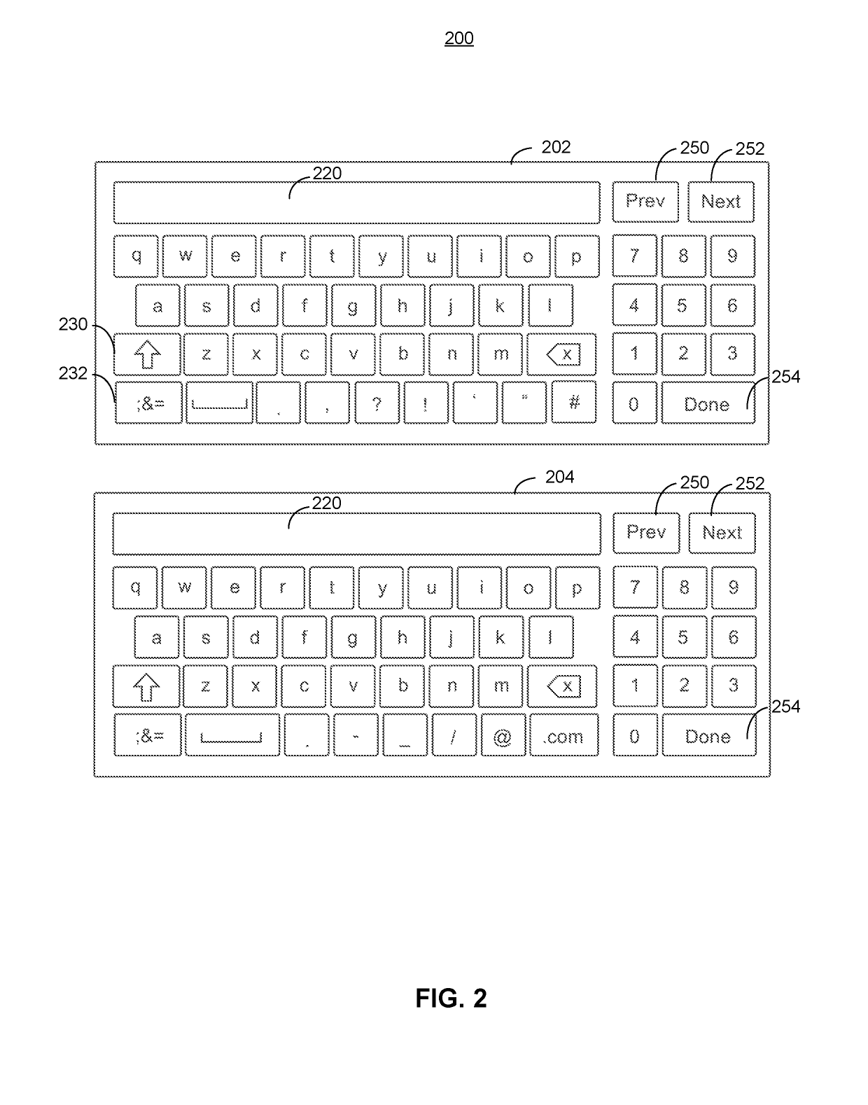

FIG. 2 illustrates two keyboard layouts 202, 204 for a virtual keyboard of an example VR system 200. In some embodiments, 3D user interface can toggle the virtual keys between different available keyboard layouts. In some implementations, the VR system determines which of the available plurality of keyboard layouts to use based on context. In some implementations, the VR system 200 can use an algorithm to automatically select a keyboard layout from the plurality of available keyboard layouts. In some other implementations, the user can manually select a keyboard layout from the plurality of available keyboard layouts.

For example, the VR system 200 can display a standard keyboard layout 202 for general purpose text entry. The VR system 200 can change the standard keyboard layout 202 to a different available keyboard layout as needed by the user.

For example, if a text field 110 requires the user to enter in an email address, the VR system can select a keyboard layout 204 specifically tailored to email addresses. The keyboard layout 204 for email addresses can include virtual keys for common characters in email addresses such as “@” or “.com”.

For example, if a user wishes to enter text in Mandarin Chinese, the VR system 200 can select a keyboard layout specifically tailored to type Mandarin Chinese characters.

In some implementations, the virtual keyboard includes a preview pane 120, 220. The preview pane 120, 220 displays the text being typed. The preview pane 120, 220 allows the user to see what they have typed without the user having to move the user's head repeatedly to view selected text fields 110, 112. The selected text fields 110, 112, which due to their locations in the virtual space, may not always be visible when using the keyboard.

In some implementations, if the user taps the preview pane 120, 220, a text cursor is displayed within the preview pane that shows the user where their typed characters will appear. If the user presses a virtual key, the preview pane 120, 220 displays the character for the virtual key to the left of the text cursor. In some related aspects, the text cursor stays at a same position relative to the character displayed to its right.

In some implementations, the design of virtual keyboard 102, 202, 204 may include “empty” space between each of the virtual keys, so that user can easily direct cursor to an empty location, thereby reducing the probability of a false positive input.

In some implementations, the virtual keyboard 102, 202, 204 includes a previous key 150, 250, a next key 152, 252, and a submit key 154, 254. The previous 150, 250, next 152, 252 and submit keys 154, 254 allow the user to quickly navigate between text fields 110, 112 without the user having to move the user's head repeatedly to manually select a previous field, to select a next field, or to select a submit button.

In some implementations, the virtual keyboard 102, 202, 204 can be set to any angle (e.g. 50 degrees) up from the horizontal plane, which may make the virtual keyboard 102, 202, 204 more comfortable for the user to read and interact with in the virtual space. When the user gazes at a particular key show on the virtual keyboard, the particular key changes color or performs an animation. The color change of the particular key that the user's gaze is hovered over denotes which key is currently being looked at.

In some implementations, the virtual keyboard 102, 202, 204 includes a cursor. For example, the cursor can be a mouse cursor, a crosshair, a dot, an animated icon, or other such visual cue. In some aspects, a user can move the cursor around the virtual space or select particular keys on the virtual keyboard 102, 202, 204 by turning the user's head. The VR system 100, 200 moves the cursor based on the HMD's direction sensors which track the rotation of the HMD on the user's head, also known as head tracking.

The virtual cursor is defined by a directional line drawn within the 3D mesh of the virtual space, starting at the zero vector or origin of the 3D mesh, at coordinate (0, 0, 0). The directional line continuously points in the direction the HMD is facing. A first object (i.e., collision object) that the directional line intercepts is the current target.

In some other implementation, the HMD of the VR system 100, 200 includes eye tracking sensors. The eye tracking sensors can allow the user to also move the cursor with eye movement in addition to or in alternative of head tracking, by tracking moving the cursor to where the user is looking.

In some implementations, the VR system 100, 200 moves the cursor based on input data received from a mouse, a trackball, a touchpad, a gamepad, a motion controller, or other such input device. For example, sensors associated with a hand held motion controller can allow a user to move his hands through the air to cause corresponding movement of the cursor in the 3D mesh of the virtual space.

In some related aspects, the collision object associated with each key on the virtual keyboard 102, 202, 204 is slightly larger than the key, creating a “sticky effect”. The stick effect can help the user target the key the user wishes to press and make the selection feel more responsive.

In some implementations, user input can be a down-event or an up-event. In some aspects, the user input is provided when the user places their finger on a touchpad in communication with the HMD. The user input could also be provided by the user pressing a button on a controller or other input device. The user input defaults to the up-event, while pressing the button or touching the touchpad triggers the down-event. The virtual keyboard's keys ignore the up-event and activate on the down-event.

When the user presses a virtual key on the virtual keyboard 102, 202, 204 In some implementations, the design of virtual keyboard 102, 202, 204 may include “empty” space between each of the virtual keys, so that user can easily direct cursor to an empty location, thereby reducing the probability of a false positive input, the VR system 100, 200 begins an animation (e.g., bounce or depression of a 3D button, a shading or changing a color of the virtual key). For example, if the user then selects (i.e., press) a particular virtual key, the virtual keyboard 102, 202, 204 shows a downward animation on the particular key to mimic the motion of a key being pressed on a physical keyboard. The downward animation provides a visual response to the user's input to provide feedback that the particular key has been successfully pressed.

In some related aspects, a sound is played if the user presses the particular key to provide further feedback to the user. In some implementations, if a second key is pressed before the sound for the first key finishes, the sound for the first key stops and a sound plays for the second key. This visual and auditory feedback provides haptic feedback to increase user engagement.

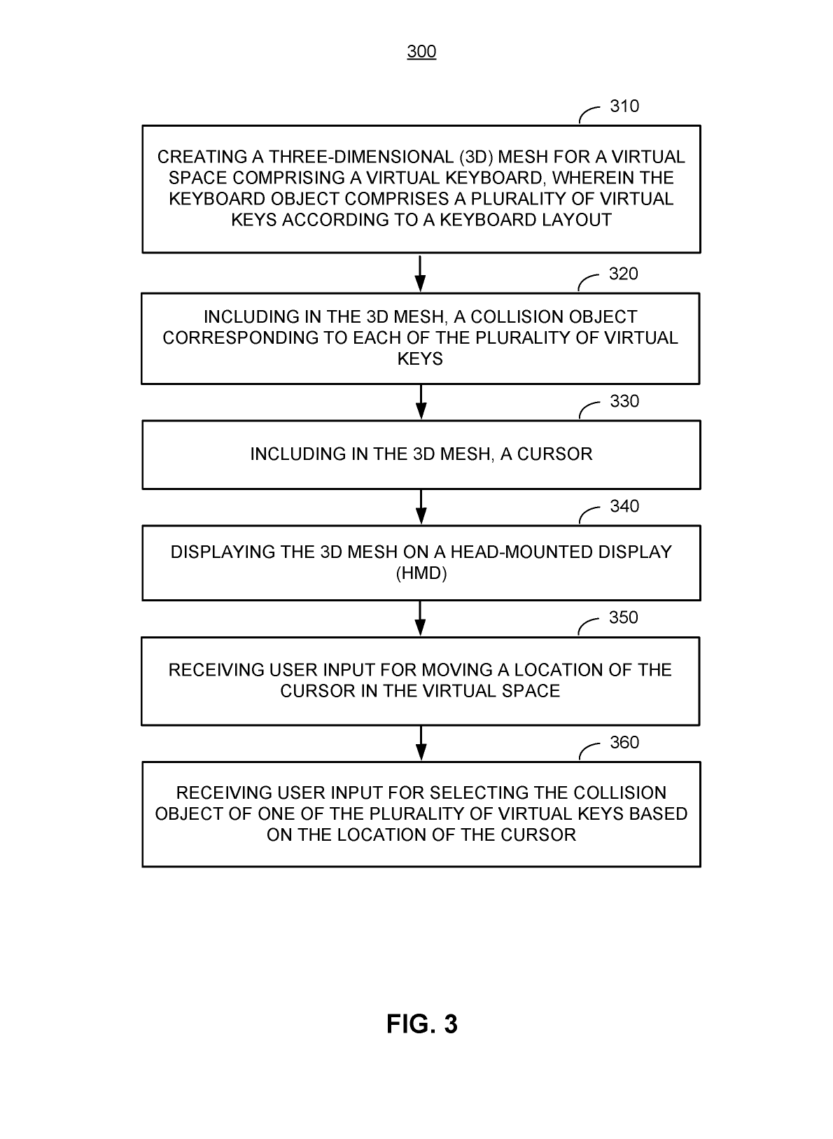

FIG. 3 illustrates an example methodology for receiving user input by a VR system. At steps 310-330, the VR system creates a three-dimensional (3D) mesh for a virtual space comprising: a virtual keyboard, wherein the keyboard object comprises a plurality of virtual keys according to a keyboard layout; a collision object corresponding to each of the plurality of virtual keys; and a cursor.

In a related aspect, the VR system selects the keyboard layout of a plurality of available keyboard layouts. In a related aspect, the plurality of available keyboard layouts comprises at least one of an alphanumeric layout, an email address layout, a web address layout, or a special characters layout. In a related aspect, the 3D mesh further comprises a preview pane for displaying typed text.

In a related aspect, the keyboard object comprises a previous key and a next key to navigate between multiple text fields.

In a related aspect, the collision object corresponding to a virtual key is larger than the virtual key.

At step 340, the VR system displays the 3D mesh on a head-mounted display (HMD).

In a related aspect, the VR system displays in the preview pane by the HMD, the one of the plurality of dynamic keys selected.

In a related aspect, displaying the three-dimensional mesh is in response to determining that a text field is selected. In a related aspect, the VR system hides the three-dimensional mesh in response to determining that the text field is unselected.

At step 350, the VR system receives user input for moving a location of the cursor in the virtual space.

In a related aspect, receiving user input for moving the location of the cursor comprises receiving sensor data for rotation of the HMD. In a related aspect, the location of the cursor is defined by an object intercepting a directional line originating from a zero vector in the 3D mesh.

In a related aspect, receiving user input for moving the location of the cursor comprises receiving movement sensor data for eye movement. In a related aspect, receiving user input for moving the location of the cursor comprises receiving input data from at least one of a mouse, a trackball, a touchpad, a gamepad, or a motion controller.

At step 360, the VR system receives user input for selecting the collision object of one of the plurality of virtual keys based on the location of the cursor.

In a related aspect, at least one of the plurality of virtual keys of the virtual keyboard is changed based on a prior user input. In a related aspect, the plurality of virtual keys changes from a set of lower case letter keys to a set of upper case letter keys, in response to selecting a shift key. In a related aspect, the plurality of virtual keys changes from a set of alphanumeric keys to a set of special characters, in response to selecting a special character key.

In a related aspect, the VR system outputs an audio cue, in response to selecting one of the plurality of virtual keys. In a related aspect, the VR system displays an animation, in response to selecting one of the plurality of virtual keys.

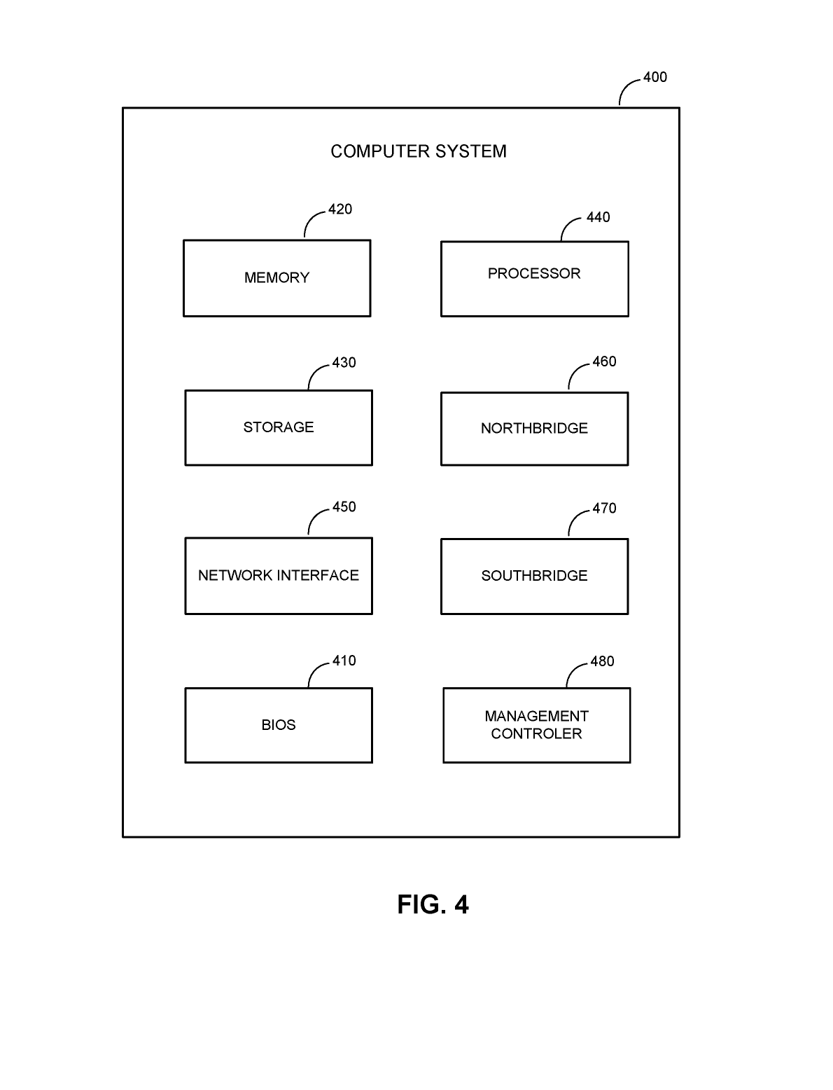

FIG. 4 illustrates a block diagram of an example computer system 400. The computer system 400 can include a processor 440, a network interface 450, a management controller 480, a memory 420, a storage 430, a Basic Input/Output System (BIOS) 410, and a northbridge 460, and a southbridge 470.

The computer system 400 can be, for example, a server (e.g., one of many rack servers in a data center) or a personal computer. The processor (e.g., central processing unit (CPU)) 440 can be a chip on a motherboard that can retrieve and execute programming instructions stored in the memory 420. The processor 440 can be a single CPU with a single processing core, a single CPU with multiple processing cores, or multiple CPUs. One or more buses (not shown) can transmit instructions and application data between various computer components such as the processor 440, memory 420, storage 430, and networking interface 450.

The memory 420 can include any physical device used to temporarily or permanently store data or programs, such as various forms of random-access memory (RAM). The storage 430 can include any physical device for non-volatile data storage such as a HDD or a flash drive. The storage 430 can have a greater capacity than the memory 420 and can be more economical per unit of storage, but can also have slower transfer rates.

The BIOS 410 can include a Basic Input/Output System or its successors or equivalents, such as an Extensible Firmware Interface (EFI) or Unified Extensible Firmware Interface (UEFI). The BIOS 410 can include a BIOS chip located on a motherboard of the computer system 400 storing a BIOS software program. The BIOS 410 can store firmware executed when the computer system is first powered on along with a set of configurations specified for the BIOS 410. The BIOS firmware and BIOS configurations can be stored in a non-volatile memory (e.g., NVRAM) 412 or a ROM such as flash memory. Flash memory is a non-volatile computer storage medium that can be electronically erased and reprogrammed.

The BIOS 410 can be loaded and executed as a sequence program each time the computer system 400 is started. The BIOS 410 can recognize, initialize, and test hardware present in a given computing system based on the set of configurations. The BIOS 410 can perform self-test, such as a Power-on-Self-Test (POST), on the computer system 400. This self-test can test functionality of various hardware components such as hard disk drives, optical reading devices, cooling devices, memory modules, expansion cards and the like. The BIOS can address and allocate an area in the memory 420 in to store an operating system. The BIOS 410 can then give control of the computer system to the OS.

The BIOS 410 of the computer system 400 can include a BIOS configuration that defines how the BIOS 410 controls various hardware components in the computer system 400. The BIOS configuration can determine the order in which the various hardware components in the computer system 400 are started. The BIOS 410 can provide an interface (e.g., BIOS setup utility) that allows a variety of different parameters to be set, which can be different from parameters in a BIOS default configuration. For example, a user (e.g., an administrator) can use the BIOS 410 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 480 can be a specialized microcontroller embedded on the motherboard of the computer system. For example, the management controller 480 can be a BMC or a RMC. The management controller 480 can manage the interface between system management software and platform hardware. Different types of sensors built into the computer system can report to the management controller 480 on parameters such as temperature, cooling fan speeds, power status, operating system status, etc. The management controller 480 can monitor the sensors and have the ability to send alerts to an administrator via the network interface 450 if any of the parameters do not stay within preset limits, indicating a potential failure of the system. The administrator can also remotely communicate with the management controller 480 to take some corrective action such as resetting or power cycling the system to restore functionality.

The northbridge 460 can be a chip on the motherboard that can be directly connected to the processor 440 or can be integrated into the processor 440. In some instances, the northbridge 460 and the southbridge 470 can be combined into a single die. The northbridge 460 and the southbridge 470, manage communications between the processor 440 and other parts of the motherboard. The northbridge 460 can manage tasks that require higher performance than the southbridge 470. The northbridge 460 can manage communications between the processor 440, the memory 420, and video controllers (not shown). In some instances, the northbridge 460 can include a video controller.

The southbridge 470 can be a chip on the motherboard connected to the northbridge 460, but unlike the northbridge 460, is not directly connected to the processor 440. The southbridge 470 can manage input/output functions (e.g., audio functions, BIOS, Universal Serial Bus (USB), Serial Advanced Technology Attachment (SATA), Peripheral Component Interconnect (PCI) bus, PCI eXtended (PCI-X) bus, PCI Express bus, Industry Standard Architecture (ISA) bus, Serial Peripheral Interface (SPI) bus, Enhanced Serial Peripheral Interface (eSPI) bus, System Management Bus (SMBus), etc.) of the computer system 400. The southbridge 470 can be connected to or can include within the southbridge 470 the management controller 470, Direct Memory Access (DMAs) controllers, Programmable Interrupt Controllers (PICs), and a real-time clock.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary designs, the functions described can be implemented in hardware, software, firmware, or any combination thereof. If implemented in software, the functions can be stored on or transmitted over as one or more instructions or code on a non-transitory computer-readable medium. Non-transitory computer-readable media includes both computer storage media and communication media including any medium that facilitates transfer of a computer program from one place to another. A storage media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for receiving user input, by a virtual reality system, comprising:
creating a three-dimensional (3D) mesh for a virtual space comprising:
a virtual keyboard, wherein the keyboard object comprises a plurality of virtual keys according to a keyboard layout;
a collision object corresponding to each of the plurality of virtual keys; and
a cursor;
displaying the 3D mesh on a head-mounted display (HMD);
receiving user input for moving a location of the cursor in the virtual space; and
receiving user input for selecting the collision object of the collision object of one of the plurality of virtual keys based on the location of the cursor.

2. The method of claim 1, further comprising selecting the keyboard layout of a plurality of available keyboard layouts.

3. The method of claim 2, wherein the plurality of available keyboard layouts comprises at least one of an alphanumeric layout, an email address layout, a web address layout, or a special characters layout.

4. The method of claim 1, wherein the 3D mesh further comprises a preview pane for displaying typed text.

5. The method of claim 4, further comprising displaying in the preview pane by the HMD, the one of the plurality of dynamic keys selected.

6. The method of claim 1, wherein receiving user input for moving the location of the cursor comprises receiving sensor data for rotation of the HMD.

7. The method of claim 6, wherein the location of the cursor is defined by an object intercepting a directional line originating from a zero vector in the 3D mesh.

8. The method of claim 1, wherein receiving user input for moving the location of the cursor comprises receiving movement sensor data for eye movement.

9. The method of claim 1, wherein receiving user input for moving the location of the cursor comprises receiving input data from at least one of a mouse, a trackball, a touchpad, a gamepad, or a motion controller.

10. The method of claim 1, wherein the keyboard object comprises a previous key and a next key to navigate between multiple text fields.

11. The method of claim 1, wherein displaying the three-dimensional mesh is in response to determining that a text field is selected.

12. The method of claim 11, further comprising hiding the three-dimensional mesh in response to determining that the text field is unselected.

13. The method of claim 1, wherein at least one of the plurality of virtual keys of the virtual keyboard is changed based on a prior user input.

14. The method of claim 13, wherein the plurality of virtual keys changes from a set of lower case letter keys to a set of upper case letter keys, in response to selecting a shift key.

15. The method of claim 13, wherein the plurality of virtual keys changes from a set of alphanumeric keys to a set of special characters, in response to selecting a special character key.

16. The method of claim 1, wherein the collision object corresponding to a virtual key is larger than the virtual key.

17. The method of claim 1, further comprising outputting an audio cue, in response to selecting one of the plurality of virtual keys.

18. The method of claim 1, further comprising displaying an animation, in response to selecting one of the plurality of virtual keys.

19. A virtual reality system, comprising:
a head-mounted display (HMD); and
a data processing device connected to the HDM configured to:
create a three-dimensional (3D) mesh for a virtual space comprising:
a virtual keyboard, wherein the keyboard object comprises a plurality of virtual keys;
a collision object corresponding to each of the plurality of virtual keys; and
a cursor;
display the 3D mesh on a HMD;
receive user input for moving a location of the cursor in the virtual space; and
receive user input for selecting the collision object of one of the plurality of virtual keys based on the location of the cursor.
